(19) United States
(12) Patent Application Publication
(10) Pub. No.: US 2012/0217226 A1
(43) Pub. Date: Aug. 30, 2012

(54) METHOD AND DEVICE FOR PRODUCING A COMPONENT OF A TURBOMACHINE

(75) Inventors: Erwin Bayer, Dachau (DE); Sven-J. Hiller, Rohrmoos (DE)

(73) Assignee: MTU AERO ENGINES GMBH, Munchen (DE)

(21) Appl. No.: 13/505,189

(22) PCT Filed: Oct. 30, 2010
(86) PCT No.: PCT/DE2010/001275

§ 371 Date: Apr. 30, 2012

(30) Foreign Application Priority Data
Oct. 31, 2009 (DE) 10 2009 051 551.8

(51) Int. Cl. B23K 10/00

(52) U.S. Cl. 219/76.16

(57) ABSTRACT

The invention relates to a method for producing a component (10) of a turbomachine, especially a structural part of a turbine or a compressor, the method being a generative production method for the layer-by-layer buildup of the component (10). After production of one or more successive component layers pressure is applied to at least sections of the surface of the most recently produced component layer (12), the pressure being induced by laser or plasma. The invention further relates to a device for producing a component (10) of a turbomachine, especially a structural part of a turbine or a compressor, the device (26) comprising at least one powder feed (28) for the deposition of at least one powder component material (16) onto a component platform, at least one radiation source (14) for a local layer-by-layer fusion or sintering of the component material (16) and at least one laser radiation source (20) or at least one plasma impulse source.

### CROSS-REFERENCE TO RELATED APPLICATIONS

This application is a U.S. National Phase application submitted under 35 U.S.C. §371 of Patent Cooperation Treaty application Ser. No. PCT/DE2010/001275, filed Oct. 30, 2010, and entitled METHOD AND DEVICE FOR PRODUCING A COMPONENT OF A TURBOMACHINE, which application claims priority to German patent application Ser No. 10 2009 051 551.8, filed Oct. 31, 2009, and entitled VERFAHREN UND VORRICHTUNG ZUR HERSTELLUNG EINES BAUTEILS EINER STRÖMUNGSMASCHINE.

Patent Cooperation Treaty application Ser. No. PCT/DE2010/001275, published as WO 2011/050790, and German patent application Ser. No. 10 2009 051 551.8, are incorporated herein by reference.

### TECHNICAL FIELD

The present invention relates to a method for the production of a component of a turbomachine, in particular a component of a turbine or of a compressor, by means of a generative manufacturing process for the layer-by-layer buildup of the component. The invention furthermore relates to a device for the production of a component of a turbomachine, in particular a component of a turbine or of a compressor.

### BACKGROUND

A great plurality of methods and devices for the production of a component of a turbomachine are known. In particular, generative manufacturing methods are known in which the component is built up layer-by-layer. In the generative production of primarily metallic components by rapid manufacturing methods or rapid prototyping methods or by laser sintering, laser powder application welding or electron beam application welding a very fine-grained component structure is produced. However, this fine-grained component structure has the disadvantage of a lack of deformability, that for example, makes possible an age-hardening and therewith a high strength comparable to a forging alloy. In order to improve the material qualities of a component after the generative buildup, the components are also worked by a hot isostatic pressing, during which the attempt is made to improve the qualities of the generatively produced component by a low-energy sintering together of different material powders and to adapt them to the qualities of a forging alloy. These qualities can also not be achieved with previous generative methods so that in particular high-temperature components or pressure-loaded components cannot be generatively produced.

### SUMMARY AND DESCRIPTION

Therefore, the present invention has the problem of making available a method for the production of a component of a turbomachine of the initially cited type that makes possible the production of components with increased strength, in particular of components of a turbine or of a compressor.

The present invention has the further problem of making a device available for the production of a component of a turbomachine that makes possible the production of components with increased strength, in particular of components of a turbine or of a compressor.

The basic problems of the invention are solved by a method with the features presented and claimed herein as well as by the device presented and claimed herein.

Advantageous embodiments with purposeful further developments of the invention are indicated in the particular subclaims, whereby advantageous embodiments of the method are to be considered as advantageous embodiments of the device and vice versa—to the extent purposeful.

A method in accordance with the invention for the production of a component of a turbomachine, in particular of a component of a turbine or of a compressor, comprises a generative manufacturing method for the layer-by-layer buildup of the component, whereby after the production of one or several successive component layers a laser-induced or plasma-induced pressure loading of the surface of the last-produced component layer takes place at least partially. As a result of the layer-by-layer strengthening of the component during the generative buildup a strengthening of the entire component takes place. The laser-induced or plasma-induced pressure loading of the surface of the last-produced component layer results in permanent plastic deformations in the structure and in a transformation of the melted structure into a forged structure with a very fine-grained structure. On the whole, a deformation of the melted structure of the component into a forged structure with increased strength results as well as a significant reduction of the microporosity already in the construction phase of the generatively produced component.

In advantageous embodiments of the method of the invention the method comprises the following steps: a) layer-by-layer application of at least one powdery component material onto a component platform, whereby the application takes place in accordance with the layer information of the component to be produced; b) layer-by-layer and local melting or sintering of the component material by at least one laser beam or electron beam for producing the component layer, whereby at least one laser or at least one electron beam device is guided over the applied layer of component material in accordance with the layer information of the component to be produced; c) at least partial laser-induced or plasma-induced pressure loading of the surface of the component layer; d) layer-by-layer lowering of the component platform by a predefined layer thickness; and e) repetition of the steps a) to d) until the component is finished. However, it is also possible that the method comprises the following steps: a) layer-by-layer application of at least one powdery component material onto a component platform, whereby the application takes place in accordance with the layer information of the component to be produced; b) layer-by-layer and local melting or sintering of the component material by at least one laser beam or electron beam for producing the component layer, whereby at least one laser or at least one electron beam device is guided over the applied layer of component material in accordance with the layer information of the component to be produced; c) layer-by-layer lowering of the component platform by a predefined layer thickness; d) repetition of the steps a) to c); e) at least partial laser-induced or plasma-induced pressure loading of the surface of the component layer; and f) repetition of the steps a) to e) until the component is finished.

The strengthening can be carried out either after each applied component layer are also after a plurality of component layers, for example, only after each fifth or tenth component layer, as a function of the penetration depth of the laser-induced or plasma-induced pressure loading. The number of strengthening steps also results in accordance with the required degree of deformation of the component and the power density of the pressure loading source. Furthermore, the generative manufacturing method can be a rapid prototyping method or rapid manufacturing method, in particular a sintering, microsintering, melting, application welding with a laser beam or electron beam. The powdery component material customarily consists of metal, a metal alloy, ceramic material, silicate or a mixture of them. In the case of the laser sintering, laser microsintering, laser melting or laser application welding a CO₂ laser or Nd:YAG laser can be used. In particular, this laser can be constructed to be pulsed.

In further advantageous embodiments of the method in accordance with the invention the laser-induced or plasma-induced pressure loading of the surface of the last-produced component layer can be carried out by a plasma shock peening, in particular by a laser shock peening by a laser beam source or a plasma impulse peening by a plasma impulse source. A short-pulse laser can be used with advantage for the laser shock peening.

In another advantageous embodiment of the method in accordance with the invention the form and the material buildup of the component is determined as a computer-generated model and the layer information generated from it is used to control at least one powder supply, the component platform, the at least one laser or the at least one electron beam device. Thus, automated and computer-controlled production processes are possible. In addition, it is possible to control the laser beam source or the plasma impulse source for producing the laser-induced or plasma-induced pressure loading also using the generated data.

A device in accordance with the invention for the production of a component of a turbomachine, in particular a component of a turbine or of a compressor, comprises at least one powder supply for applying at least one powdery component material onto a component platform, at least one beam source for a layer-by-layer and local melting or sintering of the component material as well as at least one laser beam source or at least one plasma impulse source for producing a laser-induced or plasma-induced pressure wave. The device in accordance with the invention makes possible the production of components with increased strength since it combines the carrying out of a generative manufacturing method such as, for example, a rapid prototyping method or rapid manufacturing method with the possibility of a laser-induced or plasma-induced pressure loading. The beam source here can be a laser or an electron beam device. The laser is, for example, a CO₂— or Nd:YAG laser. The laser beam source for producing the laser-induced pressure loading can be in particular a short pulse laser. The powder supply can be on the one hand an active powder supply that is arranged coaxially or laterally to the beam source for a layer-by-layer and local melting or sintering of the component material or can be a powder bed, whereby the powdery component material is applied layer-by-layer on the powder bed before the melting of sintering. Furthermore, it is possible that the strengthening process takes place parallel to the generative buildup in the same system. The laser beam source and/or the laser for the strengthening of the component and/or of the component layers can, in addition, be used to clean the component surface, so that a subsequent surface finish of the component can be eliminated. To this end only the parameters of the laser, in particular the energy power, have to be adapted. Furthermore, there is the possibility that the laser beam source or the plasma-impulse source is adjusted in such a manner that not only the strengthening step but also the melting and sintering of the component material can be carried out by the laser beam source or the plasma impulse source.

The method described above and the device described above are used in the production of driving mechanism components consisting of nickel-based alloys or titanium-based alloys, in particular for the production of compressor blades or turbine blades.

### BRIEF DESCRIPTION OF THE DRAWINGS

Further advantages, features and details of the invention result from the following description of an exemplary embodiment shown in the drawing.

FIG. 1 shows a schematic representation of a device for the production of a component of a turbomachine.

### DETAILED DESCRIPTION

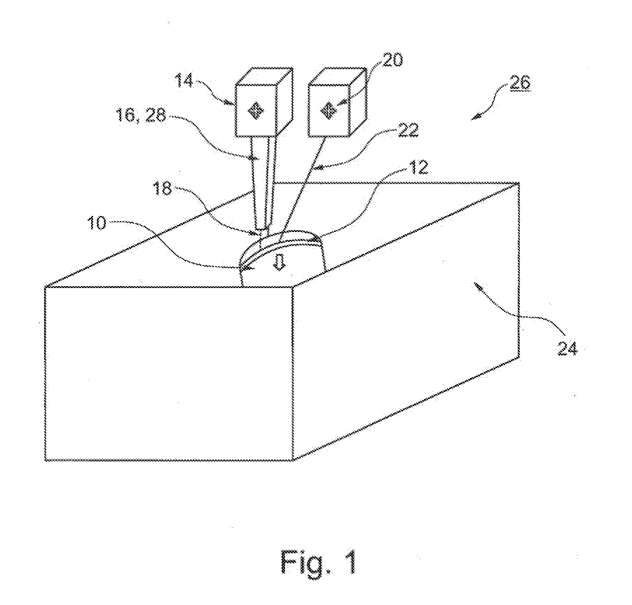

FIG. 1 shows a schematic representation of the device 26 for the production of the component 10 of a turbomachine. In the exemplary embodiment shown the component 10 is the blade of a high-pressure turbine. The device 26 comprises a beam source 14 for a layer-by-layer and local melting or sintering of a component material 16. The beam source 14 is a pulsed Nd:YAG laser in the example shown. The laser power is ca. 400 to 1000 W as a function of the construction type, in particular the blade type. The average grain size of the powdery component material 16 used is approximately 10 to 100 μm. The component material 16 consists in particular of a titanium alloy or nickel alloy. Moreover, the apparatus 26 comprises a powder supply 28 for applying the powdery component material 16 and comprises a component platform (not shown).

It can be recognized that in the example shown the powder supply 28 is arranged coaxially to the beam source 14, namely, the laser. The generated laser-and powder beam 18 is melted or sintered to a component layer 12. An application laser is used for this embodiment of the device and of the method. However, it is also possible that a sintering- or melting laser is used as beam source 18, whereby in this instance the component 10 is produced in a powder bed of a powder container 24. Both embodiments are represented in the figure.

Furthermore, the device 26 comprises a second beam source, to wit, a laser beam source 20 for producing a laser-induced pressure wave. The laser beam source 20 is a short-pulse laser that brings about a deformation and strengthening of the component layers 12 during the generative buildup by a laser-induced pressure loading of a surface of the last-produced component layer 12. At this time a laser beam 22 is guided along the surface of the last-produced component layer 12.

The manufacture of the component 10 is described by way of example in the following:

At first, the form and the material buildup of the component 10 are determined as a computer-generated model (CAD model) in a computer. The layer information generated from this is inputted as corresponding data into a control computer (not shown) of the device 26. This data serves for the control of the powder supply 28, of the component platform and of the beam source 14, to wit, the application laser. Even the laser beam source 20 for producing a pressure wave on the surface of the last-produced component layer 12 can be controlled by this information. The cited computer can also be used in particular as a control computer of the device 26. In the further course of the production of the component 10 the layer-by-layer buildup of the component 10 takes place in accordance with a generative manufacturing method as previously described. A laser-induced or plasma-induced pressure loading of the surface of the last-produced component layer 12 takes place at least partially after the production of one or more successive component layers. This results in permanent plastic deformations in the structure of the component 10 and of the individual component layer and in a transformation of the molten structure produced by the generative method into a forged structure with a very fine-grained structure.

1-17. (canceled)

18. A method for the production of a component of a turbomachine, the method comprising the following steps:
producing at least one component layer of a component by a generative manufacturing method for the layer-by-layer buildup of the component; and
after the production of one or several successive component layers, at least partially pressure loading the surface of the last-produced component layer by one of a laser-induced pressure loading or a plasma-induced pressure loading.

19. The method according to claim 18, wherein the method comprises the following steps:
a) applying, layer-by-layer, at least one powdery component material onto a component platform, whereby the application takes place in accordance with layer information of the component;
b) performing one of local melting or local sintering, layer-by-layer, of the component material by at least one of a laser beam or an electron beam for producing the component layer, whereby at least one laser or at least one electron beam device is guided over the applied layer of component material in accordance with the layer information of the component;
c) at least partially pressure loading the surface if the component layer by one of laser-induced or plasma-induced pressure loading;
d) lowering, layer-by-layer, the component platform by a predefined layer thickness; and
e) repeating the steps a) to d) until the component is finished.

20. The method according to claim 19, wherein a source for the laser beam or the plasma impulse of step c) is also a beam source for the laser beam or the electron beam for the layer-by-layer and local melting or sintering of the component material of step b).

21. The method according to claim 19, wherein:
a form and a material buildup of the component is determined as a computer-generated model; and
layer information generated from the computer-generated model it is used to control at least one of a powder supply, the component platform and the at least one laser or the at least one electron beam device.

22. The method according to claim 18, wherein the method comprises the following steps:
a) applying, layer-by-layer, at least one powdery component material onto a component platform, whereby the application takes place in accordance with the layer information of the component;
b) performing one of local melting or local sintering, layer-by-layer, of the component material by at least one of a laser beam or an electron beam for producing the component layer, whereby at least one laser or at least one electron beam device is guided over the applied layer of component material in accordance with the layer information of the component;
c) lowering, layer-by-layer, the component platform by a predefined layer thickness;
d) repeating the steps a) to c);
e) at least partially pressure loading the surface of the component layer using laser-induced or plasma-induced pressure loading; and
f) repetition of the steps a) to e) until the component is finished.

23. The method according to claim 18, wherein the method is one of a rapid prototyping method or rapid manufacturing method including one of sintering, microsintering, melting, and application welding with a laser beam or electron beam.

24. The method according to claim 23, wherein one of a CO₂ laser or a Nd:YAG laser is used for the sintering, microsintering, melting or application welding.

25. The method according to claim 24, wherein the laser is pulsed.

26. The method according to claim 18, wherein the powdery component material consists of:
a metal;
a metal alloy;
a ceramic material;
a silicate; or
a mixture of them.

27. The method according to claim 18, wherein the one of the laser-induced pressure loading or the plasma-induced pressure loading of the surface of the last-produced component layer is carried out by a plasma shock peening by one of a laser shock peening by a laser beam source or a plasma impulse peening by a plasma impulse source.

28. The method according to claim 27, wherein a short-pulse laser is used for the laser shock peening.

29. The method according to claim 18, wherein the component is one of a compressor blade or a turbine blade, formed of a nickel-based alloy or a titanium-based alloy.

30. A method for the production of a component, the method comprising the following steps:
a) determining layer information of a component from a computer-generated model;
b) applying, layer-by-layer, at least one powdery component material onto a component platform, whereby the application takes place in accordance with the layer information of the component;
c) performing one of local melting or local sintering, layer-by-layer, of the powdery component material by at least one of a laser beam or an electron beam for producing the component layer, whereby at least one laser or at least one electron beam device is guided over the applied layer of the powdery component material in accordance with the layer information of the component;
d) lowering, layer-by-layer, the component platform by a predefined layer thickness;
e) repeating the steps b) to d) at least once;
f) at least partially pressure loading the surface of the last-produced component layer by one of laser-induced or plasma-induced pressure loading;
g) repeating the steps b) to f) until the component is finished.

31. The method according to claim 30, wherein a source for the laser beam or the plasma impulse of step f) is also a beam source for the layer-by-layer and local melting or sintering of the powdery component material of step c).

32. The method according to claim 30, wherein the one of the laser-induced pressure loading or the plasma-induced pressure loading of the surface of the last-produced component layer is carried out by a plasma shock peening by one of a laser shock peening by a laser beam source or a plasma impulse peening by a plasma impulse source.

33. A device for the production of a component of a turbomachine, the device comprising:
a powder supply configured to apply at least one powdery component material onto a component platform;
at least one beam source configured for layer-by-layer and local melting or sintering of the powdery component material;
at least one of a laser beam source and a plasma impulse source configured for producing a laser-induced or plasma-induced pressure wave.

34. The device according to claim 33, wherein the beam source is one of a laser or an electron beam device.

35. The device according to claim 34, wherein the beam source is one of a CO₂ laser or Nd:YAG laser.

36. The device according to one of claim 33, wherein the beam source is a short-pulse laser.

37. The device according to claim 33, wherein the source for producing the laser-induced or plasma-induced pressure wave is also the beam source for the layer-by-layer and local melting or sintering of the component material.
